(19) United States
(12) Patent Application Publication
(10) Pub. No.: US 2007/0108648 A1
(43) Pub. Date: May 17, 2007

(54) Method for producing a moulded part

(75) Inventor: Guy Zanella, Cognin (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN VETROTEX FRANCE S.A., Chambery (FR)

(21) Appl. No.: 10/581,521

(22) PCT Filed: Dec. 1, 2004
(86) PCT No.: PCT/FR04/03078

§ 371 Date: Jun. 2, 2006

(30) Foreign Application Priority Data
Dec. 17, 2003 (FR) 0314831

(51) Int. Cl. B29C 44/04

(52) U.S. Cl. 264/45.1; 264/51

(57) ABSTRACT

The present invention relates to a process for manufacturing a moulded part, in which the moulded part is obtained by moulding at least one composite sandwich, the said sandwich incorporating an expansion agent that reacts during moulding. The invention also relates to the moulded part obtained and to the sandwich used.

The present invention relates to a process for manufacturing a strong lightweight moulded part, intended in particular for use in the automotive field or in the building industry.

Strong lightweight moulded parts are generally manufactured from composite sandwiches comprising a honeycomb core (for product lightness) and external skins placed on either side of the core (for product strength), the assembly being formed by a moulding operation, which involves at least one heating operation and at least one mechanical action (thermostamping, thermocompression, thermoforming, etc.). However, surface flaws (such as small hollows facing each hole in the honeycomb) are frequently observed in the products obtained.

The inventors have demonstrated that the heating, during manufacture of the sandwich and/or during its forming by moulding, considerably softens the core, especially if it consists of a material equivalent to that of the skins, this softening resulting in the observed surface flaws and also being prejudicial to good compressive and flexural strength of the core.

The object of the present invention was therefore to develop a moulded part superior to the products having the abovementioned drawbacks, in particular a lightweight and inexpensive composite part (or composite product) capable of withstanding the stresses associated with its use (in particular having good compressive and/or flexural strength) and having, (especially to the naked eye) a good surface appearance (in particular a taut surface appearance).

This object has been achieved by means of the process for manufacturing a moulded part according to the present invention, in which the moulded part is obtained by moulding at least one composite sandwich, the said sandwich incorporating an expansion agent that reacts during moulding.

The present invention also relates to the moulded part obtained and to the sandwich used to form the said composite and incorporating the said expansion agent capable of reacting during moulding.

The moulded part obtained is a composite, also generally of sandwich structure, this composite advantageously having a taut surface appearance (with any surface corrugations or irregularities advantageously having an amplitude of less than 50 μm, preferably less than 40 μm and in particular less than 10 μm, unlike the existing products mentioned above, in which the said amplitude is usually between 50 μm and 100 μm). This product also generally has a density of around 30 to 1200 kg/m³ and has satisfactory mechanical properties, especially compressive and/or flexural strength appropriate for various uses in the automotive field or in the building industry. This part may be a shaped part or be simply in the form of a panel. In particular, it may be in the form of a floor, for example for a vehicle, in the form of a car wheel housing, support board, a body panel, etc.

The composite sandwich used in the present invention comprises at least one core, advantageously formed from at least one thermoplastic and provided on at least one of its faces, and preferably on at least each of its two opposed faces of largest dimensions, with at least one composite skin comprising at least one reinforcing material. According to the present invention, it also incorporates at least one expansion agent capable of reacting during moulding (in particular at the temperature at which the sandwich is heated during the moulding forming operation), in particular capable of exerting pressure (in opposition to the reduced pressure causing the flaws, especially in the skin, on the surface of the sandwich) at the interface between the core and the skin during moulding.

The manufacture of the sandwich used may be carried out independently of the moulding or in a step prior to the moulding step.

The core of the sandwich is generally formed from at least one organic thermoplastic and optionally from one or more fillers and/or reinforcements, for example in order to reduce the cost and/or increase the mechanical strength of the product. The thermoplastic may for example be a polyolefin (especially polypropylene), a polyester, a polyamide, etc., preferably one identical to or compatible with (i.e. allowing good chemical adhesion to) the thermoplastic, or at least one of the thermoplastics, of the associated composite skin. The optional filler(s) may be talc, calcium carbonate, sawdust, etc., and the optional reinforcement(s) may be fibres or particles of one or more materials such as glass, carbon, aramid, etc. The material(s) of the core may be natural or synthetic materials, <<pristine>> or more advantageously recycled materials (for example the core may be obtained from recycled polypropylene). The amount of organic thermoplastic(s) within the core is preferably at least 65% by weight, that of the fillers and/or reinforcements being less than 30% by weight and that of the other materials or impurities, in particular those that are not compatible and cannot be recycled, not exceeding 5% by weight.

The core may be manufactured, for example, by extrusion, by injection moulding, by extrusion/compression moulding, etc. and may be, before complete manufacture of the sandwich by covering the core with its external skins, in the form of a honeycomb (generally of density between 80 and 120 kg/m³), or in the form of a compact or partly expanded structure, preferably one intended to be expanded (or undergo an additional expansion) during manufacture and/or moulding of the sandwich (the density obtained after expansion of these structures generally being around 700 to 1200 kg/m³), or a structure already expanded or lightened (for example a foam, this structure having a density generally of between 30 and 300 kg/m³).

The composite skin combined with the core on each face in question is preferably formed from at least one organic thermoplastic (for example chosen from polyolefins, especially polyethylene (PE), polypropylene (PP), polyesters, especially polyethylene terephthalate, polybutylene terephthalate, polyamides, polyvinyl chloride (PVC), polyphenylenesulphide, etc), and from at least one material for reinforcing this organic thermoplastic (such as glass, carbon, aramid, etc.), advantageously in the form of fibres (yarns and/or filaments), the amount of reinforcement(s) preferably being at least 50% by weight of the skin. The skin may be identical or different on each face in question and may, before it is assembled with the core, be in the form of one or more consolidated sheets and/or in the form of one or more fabrics and/or plies of parallel yarns and/or of mats, etc.

Preferably, the skin is obtained from at least one network of composite intersecting yarns, this network advantageously comprising fibres of at least one organic material, these fibres being in particular arranged alternately, inserted between or intermingled or mixed with reinforcing fibres, etc., and preferably comprises composite or commingled yarns (being composed of filaments of one of the materials and of filaments of the other material mixed together within the yarns, these yarns being obtained as described, for example, in patents EP 0 599 695, EP 0616055, EP 0 367 661 and WO 98/ 01751). Also preferably, this network is a woven or a knit or possibly a mesh, it being possible to use the same yarns or different yarns to form the warp and the weft of the network. The skin before assembly with the core may be formed from one or more networks as such, or these networks may have undergone a prior step of melting the organic material so as to be in the form of sheet(s).

The skin may also include one or more other layers (or films or constituents), in addition to the network(s), for example those based on organic material(s), and optionally including one or more additives or fillers, especially to improve the surface appearance, or to impart particular properties (UV resistance, impermeability, corrosion protection, chemical resistance, etc.).

The adhesion of the skin to the core is accomplished, for example, by lamination or thermal bonding, by heating the organic material, especially the skin (and in particular the surface of the skin), in order to allow it to bond by melting (surface melting). For example, the skin is heated by infrared just before its assembly with the core, the assembly operation also causing surface melting of the organic material of the core in the region of contact with the skin, the melting of the organic materials resulting in the mutual adhesion of the said skin and core materials. The adhesion may also be reinforced by other means, such as the addition of a hot-melt film.

The expansion agent of the sandwich and the process for producing the moulded part are chosen in accordance and according to the components of the sandwich so that the said agent acts inside the mould while the sandwich is being moulded, the triggering of the agent (in particular by decomposition or by a change of phase, with the generation of a gas) generally taking place during the moulding process, in particular during the heating prior to the actual moulding operation.

Depending on the methods of implementation, it is possible to use one or more expansion agents, including at least one that acts in the mould during moulding, in accordance with the invention. A same expansion agent, used within the present invention, may also exhibit several reaction temperatures, including at least one that triggers its reaction (in particular for generating a gas) during moulding.

The action of the expansion agent during moulding does not prevent the accomplishment of another action (by another agent and/or by the same agent, especially in the case when it has several reaction temperatures), in particular beforehand, such as an expansion of the core of the sandwich, for example in the case when a compact (or only partly expanded) core is used so as to lighten it. These various actions must, however, be clearly distinguished, any prior action carried out independently of the moulding being useless for solving the present problem. Unlike an expansion of the core, which can take place at various moments during the manufacture of the core during moulding of the sandwich, the desired action of the expansion agent in the present invention, for preventing the appearance of surface flaws, must itself be designed or retained, at least in part, whenever necessary, so as to take place, at least in part, during moulding.

Where appropriate, the expansion agent may be coupled with an appropriate inhibitor, for example preventing it from reacting until the heating during moulding (it being possible for the inhibitor to act over a limited duration or until a given temperature is reached) and/or the process is designed so that the moulding operation is carried out just after the desired triggering of the agent.

The expansion agent(s), and where appropriate the inhibitor(s), may be incorporated at different points in the sandwich. According to a first embodiment, in particular the expansion agent according to the invention may be added in the bulk of the core, for example by mixing the material or materials that have to form the core, especially in the extruder used to manufacture the core. If expansion of the core is envisaged in parallel, the corresponding agent is normally incorporated into the core during its manufacture, it being possible for this agent to react during formation of the core, especially if it is an agent different from that used according to the invention or if it is the same agent but having at least two reactivities or this agent possibly acting subsequently, independently of or in parallel with the desired action according to the invention.

According to another embodiment, the expansion agent may be applied to the core and/or its skin, for example the core may be dipped into a solution or dispersion of the expansion agent and/or may be coated with a film or with a composition comprising the expansion agent, in particular on its faces that have to receive the skin. In parallel, or alternatively, it may be the skin that is dipped, or the skin that is coated on its face intended to be in contact with the core.

Where appropriate (for example when certain honeycomb cores are used), the temperatures to which the skin is heated in order to join it to the core may be higher than the temperatures at which the said sandwich is subsequently moulded, however, regarding generally in the case of assembly the fact that it is surface heating and not core heating, the action of the expansion agent according to the invention may be mostly preserved provided that the said agent is present within the thickness of the core and not only on the surface, and/or may be preserved if the expansion agent is coupled with an inhibitor, the decomposition of which is initiated, for example, during the said assembly.

Optionally, another particular case is not excluded in which the desired action of the expansion agent according to the invention is initiated during manufacture of the sandwich, this embodiment then requiring moulding to be carried out as soon as possible after assembling the skin, before the action of the expansion agent has been completed.

However, the most practical case remains that in which the heating associated with the making of the sandwich (in particular the assembly operation) takes place at a lower temperature than that associated with the moulding of the sandwich (case of many compact or foam structures for which the making takes place at a temperature of a few tens of degrees below the moulding temperature), it being possible to preserve the reactivity of the expansion agent within the context of the present invention until the heating during moulding, especially by choosing an agent having a reaction temperature corresponding to that of the heating during moulding, or by coupling it with an inhibitor that decomposes, for example, at this moulding temperature.

Whatever the chosen method of incorporation, the content of expansion agent(s) according to the present invention, chosen to act during moulding, preferably represents from 0.5 to 5% by weight of the core.

Various types of expansion agents may be used depending on the materials and the process chosen. In particular, it is not excluded to use water as a particularly simple expansion agent, the core for example being impregnated by dipping it before the skin is added, this method of implementation normally requiring the moulding to be carried out as soon as possible after assembling the skin, the assembly temperatures (for example around 150 to 180° C.) possibly causing excess generation of steam making it possible to obtain the desired effect in the present invention.

More generally, the expansion agent is mainly chosen from agents such as exothermic blowing agents (or pore formers), for example azodicarbonamide, sulphonyl hydrazide, etc. or endothermic agents such as sodium bicarbonate/citric acid mixtures, etc.

As indicated above, the making of the sandwich may be independent of or prior to moulding (or shaping by moulding) of the sandwich.

In one continuous process for manufacturing the sandwich, the core is for example formed by mixing all its constituents, for example in the form of granules or powder, in at least one extruder (including where appropriate the expansion agent(s) or any other additive), the extruder being fed for example via at least one hopper and the core being formed by passage through at least one die (for example a sheet extrusion die) at the exit of the extruder and generally by passing through at least one additional forming device—such as a die or shaping tool, etc.—after the extrusion die, and is then coated on at least one of its faces with a composite skin as defined above.

This skin is for example unwound in the form of at least one continuous sheet, for example of fabric(s), which may or may not be consolidated, from at least one winding. Simultaneously or not, an identical or similar device may allow the same face or another face (in particular the opposite face) of the core to be coated with an identical or different skin. Before application to the core, each composite skin is advantageously reheated (for example by passing beneath an infrared radiation source), the melting of the organic material of the skin allowing it to adhere to the core (or where appropriate to an intermediate layer), and optionally preconsolidated (in particular when woven fabrics are unwound in non-consolidated form) by passing, for example, through at least one calender. The adhesion of the skin to the core may also take place via an adhesive or a hot-melt film. The adhesion between the various layers may also be promoted by using at least one calender through which the core provided with its skin passes, this calender generally being located at the point where the skin comes into contact with the core.

Alternatively, the skin or part of the skin may be added to the core directly in the core extrusion die and/or between two additional shaping or assembling devices.

Where appropriate, the core and/or the skin may be coated or impregnated with a film or with a composition comprising the expansion agent before they are combined.

The assembly obtained may then be cut (in line or otherwise). The sandwiches ready for moulding generally have a thickness of between 5 and 40 mm (it should be noted that this thickness is essentially provided by the core, the thickness of the skin on each of the faces in question being comparatively very small, particularly less than 10% of that of the sandwich).

As an alternative manufacturing process, this alternative process being generally discontinuous, in the case of large-sized sandwiches, several extruded cores may be welded together before joining the composite skin to the assembly. Another discontinuous method may also consist in injecting the molten material that has to form the core into a mould and then in applying the skin to the core formed, by hot compression moulding.

The sandwich is moulded in an operation following or subsequent to its manufacture, this operation generally consisting in heating or reheating the manufactured sandwich to the required temperature for moulding, generally to the softening temperature of the organic material of the core and of the skin (for example to a temperature of around 200-230° C. in the case of a sandwich initially formed from a polypropylene-based core, the making of such a sandwich taking place at temperatures below around 180-200° C.), this temperature also causing (in particular if not initiated during making of the sandwich in the case of consecutive moulding) the reaction (for example the decomposition or the phase change) of the expansion agent. The sandwich thus heated is rapidly transferred (for example in 5 to 15 seconds) into a conversion mould, this mould being for example maintained at a temperature of around 40 to 100° C., the part being formed, for example, by stamping, compression moulding, etc., generally at a pressure ranging, for example, from 2 to 100 bar. The reaction of the expansion agent advantageously causes a gas to be generated, which exerts a backpressure or makes the pressure uniform in the part during moulding, the composite skin being pressed uniformly against the walls of the mould without forming depressions associated with the structure of the core, and/or without softening the core, which would prejudice its strength, for example its compressive strength.

Inserts or other elements may be added, for example fastening devices, suspension devices, etc., which may be positioned in the mould before introduction of the sandwich, or decorative elements may be bonded by thermal bonding, such as decorative films, carpet, laminate or wood facing, etc.

After the moulded part has cooled, sufficiently to manipulate it, it may be demoulded and, if needed, cut or deflashed, before or after demoulding.

The moulded parts according to the invention may be used especially in motor vehicles or building. For example, they may be vehicle floors, spare wheel housings, support boards, body panels, scaffolding planks, etc.

1. Process for manufacturing a moulded part, in which the moulded part is obtained by moulding at least one composite sandwich, the said sandwich incorporating an expansion agent that reacts during moulding.

2. Process according to claim 1, characterized in that the expansion agent is incorporated into the core of the sandwich.

3. Process according to claim 1, characterized in that the expansion agent is applied to the core and/or its skin.

4. Moulded part or composite, having an amplitude of surface corrugations or irregularities of less than 50 μm and a density of around 30 to 1200 kg/m³.

5. Composite sandwich comprising at least one core provided on at least one of its faces with at least one composite skin comprising at least one reinforcing material, and comprising at least one expansion agent capable of reacting at the moulding temperature of the sandwich.
